(19) United States
(12) Patent Application Publication
(10) Pub. No.: US 2020/0064970 A1
(43) Pub. Date: Feb. 27, 2020

(54) TOUCH PANEL, DISPLAY PANEL, DISPLAY DEVICE AND TOUCH DETECTING METHOD

(71) Applicant: Wuhan China Star Optoelectronics Semiconductor Display Technology Co., Ltd., Wuhan (CN)

(72) Inventor: Hui CHEN, Wuhan (CN)

(73) Assignee: Wuhan China Star Optoelectronics Semiconductor Display Technology Co., Ltd., Wuhan (CN)

(21) Appl. No.: 16/317,830

(22) PCT Filed: Sep. 11, 2018
(86) PCT No.: PCT/CN2018/105021

§ 371 Date: Jan. 15, 2019

(30) Foreign Application Priority Data
Aug. 3, 2018 (CN) 201810875928.2

(51) Int. Cl. G06F 3/044

(52) U.S. Cl. CPC G06F 3/0446; G06F 2203/04111; G06F 2203/04105

(57) ABSTRACT

This disclosure provides a touch panel, a display panel, a display device and a touch detecting method. Wherein the touch panel comprises a plurality of induction modules disposed apart from each other, and the adjacent induction modules formed a capacitor; a pressure detecting module electrically connected to the plurality of induction modules, and configured to generate a pressure value corresponding to a pressure according to various capacitances of the capacitor between the corresponding adjacent induction modules when the touch panel being pressed.

### BACKGROUND

### 1. Field of Invention

The present disclosure relates to the field of display technology, and more particularly to a touch panel, a display panel, a display device and a touch detecting method.

### 2. Description of the Prior Art

Touch technology is a primary input way for man-machine interface. The touch technology includes a two-dimensional touch technology and a three-dimensional touch technology. The two-dimensional touch technology mainly performs a multi-touch recognition on a two-dimensional panel composed of an X-axis and a Y-axis. The three-dimensional touch technology adds a touch recognition of a Z-axis based on the two-dimensional touch technology.

Users can perform different operations on a terminal device by adjusting pressing force on the terminal device using the three-dimensional touch technology. For example, a speed, a jump level and so on can be controlled by a pressure degree exerted on a mobile phone when playing games on the mobile phone.

However, conventional pressure value detecting method has a poor accuracy. Therefore, a method for an accurate touch recognition along a Z-axis direction is needed to be provided to improve a detecting accuracy of the pressure value.

### SUMMARY

An object of the present disclosure is to provide a touch panel, a display panel, a display device and a touch detecting method, which can improve a detecting accuracy of a pressure value exerted on the touch panel.

The present disclosure provides a touch panel including: a plurality of induction modules disposed apart from each other, and the adjacent induction modules formed a capacitor; a pressure detecting module electrically connected to the plurality of induction modules, and configured to generate a pressure value corresponding to a pressure according to various capacitances of the capacitor between the corresponding adjacent induction modules when the touch panel being pressed.

In some embodiments of the present disclosure, each of the plurality of induction modules includes a bump and a conductive layer.

The plurality of bumps are distributed in a grid shape, two adjacent bumps disposed along a first direction are connected by a bridge and two adjacent bumps disposed along a second direction are connected by another bridge, and the first direction intersects with the second direction.

The conductive layer is disposed on the bump and wraps the bump.

In some embodiments of the present disclosure, a height H of the bump ranges from 100 to 300 um, a width W of the bump ranges from

$$\frac{H}{2}$$

to H um, and a separation distance L between two adjacent bumps ranges from

$$\frac{W}{5}$$

### to W um.

In some embodiments of the present disclosure, the bump includes a plurality of sub-bumps and a plurality of wires disposed at edges of the bump. Each of the plurality of wires is connected to the corresponding sub-bump.

In some embodiments of the present disclosure, materials of the conductive layer include metal materials or graphite.

In some embodiments of the present disclosure, the pressure detecting module includes a capacitance detecting module and a pressure generating module.

The capacitance detecting module is configured to detect a first capacitance of the capacitor between the corresponding adjacent induction modules before the touch panel is pressed, and to detect a second capacitance of the capacitor between the corresponding adjacent induction modules when the touch panel being pressed.

The pressure generating module is configured to generate the pressure value according to a difference between the second capacitance and the first capacitance when the touch panel being pressed.

The present disclosure provides a display panel, including an organic light-emitting device, a support layer, a buffer layer, and a touch panel.

The touch panel, the buffer layer, the support layer and the organic light-emitting device are sequentially stacked, and the buffer layer is disposed on the touch panel.

The touch panel includes: a plurality of induction modules disposed apart from each other, and the adjacent induction modules formed a capacitor; a pressure detecting module electrically connected to the plurality of induction modules, and configured to generate a pressure value corresponding to a pressure according to various capacitances of the capacitor between the corresponding adjacent induction modules when the touch panel being pressed.

In some embodiments of the present disclosure, each of the plurality of induction modules includes a bump and a conductive layer.

The plurality of bumps are distributed in a grid shape, two adjacent bumps disposed along a first direction are connected by a bridge and two adjacent bumps disposed along a second direction are connected by another bridge, and the first direction intersects with the second direction.

The conductive layer is disposed on the bump and wraps the bump.

In some embodiments of the present disclosure, a height H of the bump ranges from 100 to 300 um, a width W of the bump ranges from

$$\frac{H}{2}$$

to H um, and a separation distance L between two adjacent bumps ranges from

$$\frac{W}{5}$$

### to W um.

In some embodiments of the present disclosure, the bump includes a plurality of sub-bumps and a plurality of wires disposed at edges of the bump. Each of the plurality of wires is connected to the corresponding sub-bump.

In some embodiments of the present disclosure, materials of the conductive layer include metal materials or graphite.

In some embodiments of the present disclosure, the pressure detecting module includes a capacitance detecting module and a pressure generating module.

The capacitance detecting module is configured to detect a first capacitance of the capacitor between the corresponding adjacent induction modules before the touch panel is pressed, and to detect a second capacitance of the capacitor between the corresponding adjacent induction modules when the touch panel being pressed.

The pressure generating module is configured to generate the pressure value according to a difference between the second capacitance and the first capacitance when the touch panel being pressed.

In some embodiments of the present disclosure, the display panel includes a heat dissipating layer. The heat dissipating layer is disposed on a side of the buffer layer away from the support layer. The touch panel is disposed on a side of the heat dissipating layer away from the buffer layer.

The present disclosure further provides a display device, including a rear cover, a middle frame, a display panel and a touch panel. The middle frame is disposed on the rear cover, and the middle frame and the rear cover are configured to form a containing space. The touch panel is disposed on a side of the middle frame adjacent to the rear cover and is disposed in the containing space. The touch panel is disposed on a side of the middle frame adjacent to the rear cover and is disposed in the containing space. The display panel is disposed on the touch panel.

The touch panel includes: a plurality of induction modules disposed apart from each other, and the adjacent induction modules formed a capacitor; a pressure detecting module electrically connected to the plurality of induction modules, and configured to generate a pressure value corresponding to a pressure according to various capacitances of the capacitor between the corresponding adjacent induction modules when the touch panel being pressed.

In some embodiments of the present disclosure, each of the plurality of induction modules includes a bump and a conductive layer.

The plurality of bumps are distributed in a grid shape, two adjacent bumps disposed along a first direction are connected by a bridge and two adjacent bumps disposed along a second direction are connected by another bridge, and the first direction intersects with the second direction.

The conductive layer is disposed on the bump and wraps the bump.

In some embodiments of the present disclosure, a height H of the bump ranges from 100 to 300 um, a width W of the bump ranges from

$$\frac{H}{2}$$

to H um, and a separation distance L between two adjacent bumps ranges from

$$\frac{W}{5}$$

### to W um.

In some embodiments of the present disclosure, the bump includes a plurality of sub-bumps and a plurality of wires disposed at edges of the bump. Each of the plurality of wires is connected to the corresponding sub-bump.

In some embodiments of the present disclosure, materials of the conductive layer include metal materials or graphite.

In some embodiments of the present disclosure, the pressure detecting module includes a capacitance detecting module and a pressure generating module.

The capacitance detecting module is configured to detect a first capacitance of the capacitor between the corresponding adjacent induction modules before the touch panel is pressed, and to detect a second capacitance of the capacitor between the corresponding adjacent induction modules when the touch panel being pressed.

The pressure generating module is configured to generate the pressure value according to a difference between the second capacitance and the first capacitance when the touch panel being pressed.

The present disclosure also provides a touch detecting method for touch detecting by the touch panel above, including: obtaining position information of a pressure when the touch panel being pressed; determining various capacitances between corresponding induction modules according to the position information of the pressure; generating a pressure value of the pressure according to the various capacitances.

In the touch panel, the display panel, the display device and the touch detecting method of the present disclosure, the plurality of induction modules disposed apart from each other are arranged at first, wherein the adjacent induction modules are formed a capacitor. Subsequently, a pressure value is generated to improve a detecting accuracy of the pressure value according to a various capacitance of the capacitor between the corresponding adjacent induction modules.

### BRIEF DESCRIPTION OF DRAWINGS

Aforementioned contents of the present disclosure will be better understood with reference to the following description, and accompanying figures.

FIG. 1 is a structural schematic diagram of a touch panel according to the present disclosure.

FIG. 2 is a scenario schematic diagram of a touch detecting method according to the present disclosure.

FIG. 3 is a structural schematic diagram of an induction module according to the present disclosure.

FIG. 4 is a structural schematic diagram of a bump according to the present disclosure.

FIG. 5 is a structural schematic diagram of a display panel according to the present disclosure.

FIG. 6 is another structural schematic diagram of a display panel according to the present disclosure.

FIG. 7 is a structural schematic diagram of a display device according to the present disclosure.

FIG. 8 is a flowchart of a touch detecting method according to the present disclosure.

### DETAILED DESCRIPTION OF PREFERRED EMBODIMENTS

The following description of each embodiment with reference to the accompanying drawings is used to exemplify a specific embodiment which may be carried out in the present disclosure. Directional terms mentioned in the present disclosure, such as “top”, “bottom”, “front”, “back”, “left”, “right”, “inside”, “outside”, “side” etc., are only used with reference to the orientation of the accompanying drawings. Therefore, the used directional terms are intended to illustrate, but not to limit, the present disclosure. Examples of the described embodiments are given in the accompanying drawings, wherein the identical or similar reference numerals constantly denote the identical or similar elements or elements having the identical or similar functions.

Descriptions in the specification referred to “embodiment” mean that a particular feature, structure, or characteristic described in connection with the embodiment is included in at least one embodiment. Thus, appearances of the phrases “embodiment” in places throughout the specification are may be combined in any suitable manner in one or more embodiments. Thus, the particular features, structures, or characteristics illustrated or described in connection with one embodiment may be combined, in whole or in part, with the features structures, or characteristics of one or more other embodiments without limitation. Such modifications and variations are intended to be included within the scope of the present invention.

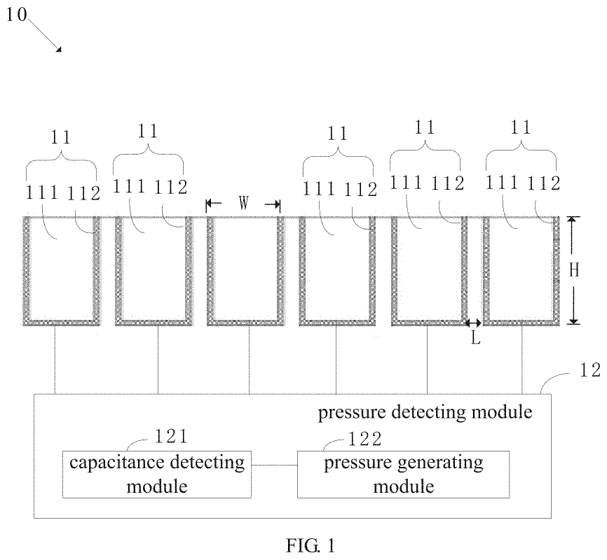

The present disclosure provides a touch panel. Referring to FIG. 1, FIG. 1 is a structural schematic diagram of the touch panel according to the present disclosure. The touch panel 10 includes a plurality of induction modules 11 and a pressure detecting module 12.

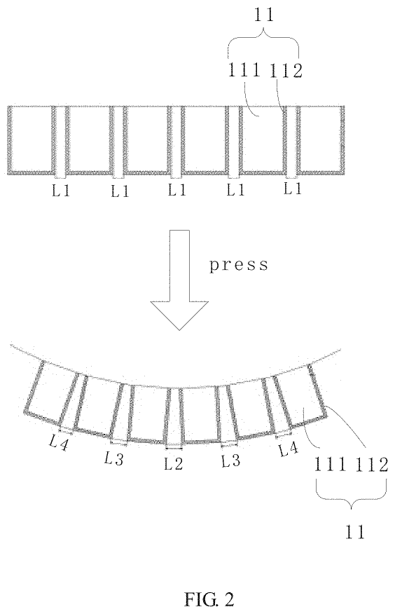

As shown in the FIG. 1, the plurality of induction modules 11 are disposed apart from each other, and the adjacent induction modules are formed a capacitor. As shown in the FIG. 2, when the touch panel 10 not being pressed, a separation distance between the adjacent bumps 11 is L1, and a capacitance of the capacitor between the adjacent induction modules is

$$\frac{ɛ \cdot s}{4 k π \cdot L 1} ,$$

wherein the ε is a permittivity of mediums disposed between the adjacent induction modules 11, the k is a electrostatic force constant, and the S is a relative area of the adjacent induction modules 11. When a middle position of the touch panel 10 being pressed, a separation distance between two adjacent induction modules corresponding to the middle position is increased to L2, a separation distance between two adjacent induction modules corresponding to two sides closed to the middle position is increased to L3, and a separation distance of two adjacent induction modules corresponding to two sides away from the middle position is increased to L4. Similarly, capacitances of the capacitor between the adjacent induction modules 11 corresponding to relevant positions can be calculated to be

$$\frac{ɛ \cdot s}{4 k π \cdot L 2} , \frac{ɛ \cdot s}{4 k π \cdot L 3} and \frac{ɛ \cdot s}{4 k π \cdot L 4} .$$

Subsequently, a pressure value corresponding to a pressing can be generated according to various capacitances of the capacitor between the adjacent induction module 11 before and after the pressing.

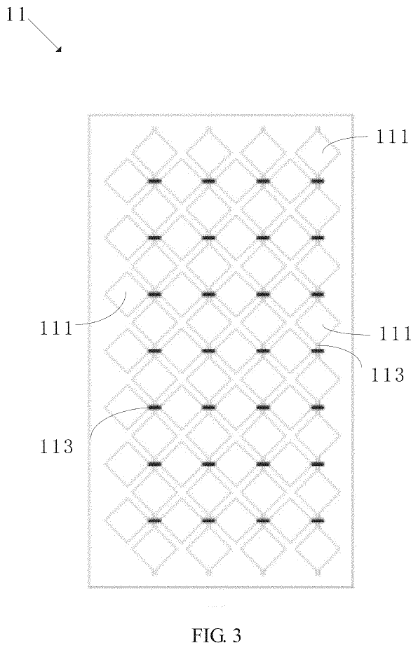

Specifically, as shown in the FIG. 1, each induction module 11 includes a bump 111 and a conductive layer 112. There are a plurality of bumps 111 corresponding to the plurality of induction modules 11 accordingly. As shown in FIG. 3, the plurality of bumps 111 are distributed in a grid shape, two adjacent bumps 111 disposed along a first direction are connected by a bridge 113 and two adjacent bumps disposed along a second direction are connected by another bridge 113, and the first direction intersects with the second direction. According to an embodiment, the first direction can be a horizontal direction, and the second direction can be a vertical direction.

Materials of the bump 111 includes polyimide photoresists. As shown in FIG. 1, in order to improve a capacitance detecting accuracy of the induction module 11, a height H of the bump 111 can be ranged from 100 to 300 um, a width W of the bump 111 can be ranged from

$$\frac{H}{2}$$

to H um, and a separation distance L of two adjacent bumps 111 can be ranged

$$\frac{W}{5}$$

from to W um.

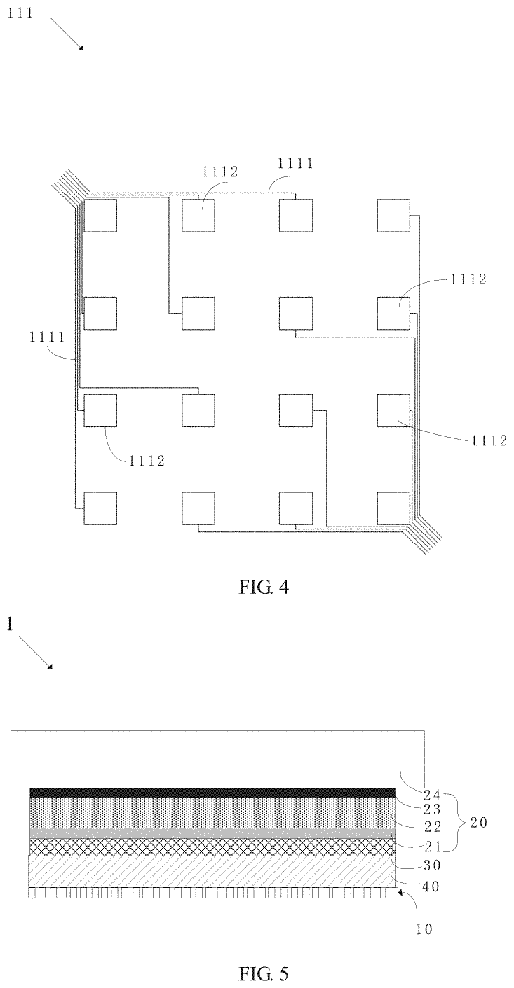

As shown in FIG. 4, the bump 111 includes a plurality of sub-bumps 1112, and a plurality of wires 1111 disposed at edges of the bump 111 wherein each of the plurality of wires 111 is connected to the corresponding sub-bump 1112.

The conductive layer 112 is disposed on the bump 111 and wraps the bump 111. Materials of the conductive layer 112 includes metal materials or graphite. According to an embodiment, the metal material is indium tin oxide.

As shown in FIG. 1, the pressure detecting module 12 is electrically connected to the plurality of induction modules 11. The pressure detecting module 12 is configured to generate a pressure value corresponding to a pressure according to various capacitances of the capacitor between the corresponding adjacent induction modules 11 before and after the touch panel 10 being pressed.

According to some embodiments, as shown in FIG. 1, the pressure detecting module 12 includes a capacitance detecting module 121 and a pressure generating module 122, wherein the capacitance detecting module 12 can detect a first capacitance of the capacitor between the corresponding adjacent induction modules 11 before the touch panel 10 is pressed, and detect a second capacitance of the capacitor between the corresponding adjacent induction modules 11 after the touch panel 10 is pressed. As shown in FIG. 2, the first capacitance detected by the capacitance detecting module 12 is

$$\frac{ɛ \cdot s}{4 k π \cdot L 1}$$

before the touch panel 10 is pressed, and the second capacitances detected by the capacitance detecting module 12 include

$$\frac{ɛ \cdot s}{4 k π \cdot L 2} , \frac{ɛ \cdot s}{4 k π \cdot L 3} and \frac{ɛ \cdot s}{4 k π \cdot L 4}$$

after the touch panel 10 is pressed, wherein the second capacitance between two induction modules 11 corresponding to the middle position is

$$\frac{ɛ \cdot s}{4 k π \cdot L 2} ,$$

the second capacitance between two adjacent induction modules 11 adjacent to the middle position is

$$\frac{ɛ \cdot s}{4 k π \cdot L 3} ,$$

the second capacitance between two adjacent induction modules 11 away from the middle position is

$$\frac{ɛ \cdot s}{4 k π \cdot L 4} .$$

At last, the pressure value corresponding to the pressure is generated by the pressure generating module 122 according to a difference between the second capacitance and the first capacitance. Specifically, the difference between the second capacitance and the first capacitance, the pressure value, and a relationship between them can be stored in advance, as shown in following table 1.

TABLE 1

| a difference between the second capacitance and | |
|---|---|
| the first capacitance | pressure value |
| ΔC1 | P1 |
| ΔC2 | P2 |
| ΔC2 | P3 |

In this way, the pressure generating module 122 can calculate the difference between the second capacitance and the first capacitance after the capacitance detecting module 121 detects the first capacitance and the second capacitance. Subsequently, the pressure value corresponding to the difference can be found directly in the table 1. For example, as shown in FIG. 2, the pressure value corresponding to the middle position can be found according to the difference between the second capacitance and the first capacitance corresponding to the middle position, and the pressure value corresponding to the middle position can be found according to the difference between the second capacitance and the first capacitance close to the middle position.

In the touch panel of the present disclosure, the plurality of induction modules disposed apart from each other are arranged at first, wherein the adjacent induction modules are formed a capacitor. Subsequently, a pressure value is generated to improve a detecting accuracy of the pressure value according to a various capacitance of the capacitor between the corresponding adjacent induction modules.

The disclosure also provides a display panel. Referring to FIG. 5, FIG. 5 is a structural schematic diagram of the display panel according to the present disclosure. The display panel 1 includes a touch panel 10, an organic light-emitting device 20, a support layer 30 and a buffer layer 40. The touch panel 10, the buffer layer 40, the support layer 30 and the organic light-emitting device 20 are sequentially stacked, and the buffer layer 40 is disposed on the touch panel 10.

The organic light-emitting device 20 includes a light-emitting layer 21, a polarizer 22, a touch layer 23 and a cover plate 24 sequentially stacked. The light-emitting layer 21 is disposed on the support layer 30. Specifically, the light-emitting layer 21 includes a thin-film transistor layer, an organic light-emitting layer and encapsulation layer, wherein the thin-film transistor layer is configured to drive the organic light-emitting layer. The encapsulation layer is configured to isolate external water and oxygen. According to an embodiment, the encapsulation layer is a thin-film encapsulation layer, and the thin-film encapsulation layer can be formed by combining a plurality of organic-inorganic thin-films, specifically. The polarizer 22 is fixed on the encapsulation layer, and optical cement can be coated on the encapsulation layer to fix the polarizer 22. The polarizer 22 is configured to adjust incident lights outside. A plurality of touch electrodes are disposed on the touch layer 23 to assist the touch panel 10 to implement touch function. The cover plate 24 has a characteristic of high hardness, and a layer with large roughness can be disposed thereon to improve a roughness characteristic of the display panel 1.

The support layer 30 is configured to support the organic light-emitting device 20. Specifically, the support layer 30 can be made of polyethylene glycol terephthalate or other materials. The buffer layer 40 is configured to reduce pressure exerted on the display device 1.

The touch panel 10 includes a plurality of induction modules 11 and a pressure detecting module 12. As shown in the FIG. 1, the plurality of induction modules 11 are disposed apart from each other, and the adjacent induction modules are formed a capacitor. As shown in the FIG. 2, when the touch panel 10 not being pressed, a separation distance between the adjacent bumps 11 is L1, and a capacitance of the capacitor between the adjacent induction modules is

$$\frac{ɛ \cdot s}{4 k π \cdot L 1} ,$$

wherein the ε is a permittivity of mediums disposed between the adjacent induction modules 11, the k is a electrostatic force constant, and the S is a relative area of the adjacent induction modules 11. When a middle position of the touch panel 10 being pressed, a separation distance between two adjacent induction modules corresponding to the middle position is increased to L2, a separation distance between two adjacent induction modules corresponding to two sides closed to the middle position is increased to L3, and a separation distance of two adjacent induction modules corresponding to two sides away from the middle position is increased to L4. Similarly, capacitances of the capacitor between the adjacent induction modules 11 corresponding to relevant positions can be calculated to be

$$\frac{ɛ \cdot s}{4 k π \cdot L 2} , \frac{ɛ \cdot s}{4 k π \cdot L 3} and \frac{ɛ \cdot s}{4 k π \cdot L 4} .$$

Subsequently, a pressure value corresponding to a pressing can be generated according to various capacitances of the capacitor between the adjacent induction module 11 before and after the pressing.

Specifically, as shown in the FIG. 1, each induction module 11 includes a bump 111 and a conductive layer 112. There are a plurality of bumps 111 corresponding to the plurality of induction modules 11 accordingly. As shown in FIG. 3, the plurality of bumps 111 are distributed in a grid shape, two adjacent bumps 111 disposed along a first direction are connected by a bridge 113 and two adjacent bumps 111 disposed along a second direction are connected by another bridge 113, and the first direction intersects with the second direction. According to an embodiment, the first direction can be a horizontal direction, and the second direction can be a vertical direction.

Materials of the bump 111 includes polyimide photoresists. As shown in FIG. 1, in order to improve a capacitance detecting accuracy of the induction module 11, a height H of the bump 111 can be ranged from 100 to 300 um, a width W of the bump 111 can be ranged from

$$\frac{H}{2}$$

to H um, and a separation distance L of two adjacent bumps 111 can be ranged

$$\frac{W}{5}$$

from to W um.

As shown in FIG. 4, the bump 111 includes a plurality of sub-bumps 1112, and a plurality of wires 1111 disposed at edges of the bump 111, wherein each of the plurality of wires 111 is connected to the corresponding sub-bump 1112.

The conductive layer 112 is disposed on the bump 111 and wraps the bump 111. Materials of the conductive layer 112 includes metal materials or graphite. According to an embodiment, the metal material is indium tin oxide.

As shown in FIG. 1, the pressure detecting module 12 is electrically connected to the plurality of induction modules 11. The pressure detecting module 12 is configured to generate a pressure value corresponding to a pressure according to various capacitances of the capacitor between the corresponding adjacent induction modules 11 before and after the touch panel 10 being pressed.

According to some embodiments, as shown in FIG. 1, the pressure detecting module 12 includes a capacitance detecting module 121 and a pressure generating module 122, wherein the capacitance detecting module 12 can detect a first capacitance of the capacitor between the corresponding adjacent induction modules 11 before the touch panel 10 is pressed, and detect a second capacitance of the capacitor between the corresponding adjacent induction modules 11 after the touch panel 10 is pressed.

As shown in FIG. 2, the first capacitance detected by the capacitance detecting module 12 is

$$\frac{ɛ \cdot s}{4 k π \cdot L 1}$$

before the touch panel 10 is pressed, and the second capacitances detected by the capacitance detecting module 12 include

$$\frac{ɛ \cdot s}{4 k π \cdot L 2} , \frac{ɛ \cdot s}{4 k π \cdot L 3} and \frac{ɛ \cdot s}{4 k π \cdot L 4}$$

after the touch panel 10 is pressed, wherein the second capacitance between two induction modules 11 corresponding to the middle position is

$$\frac{ɛ \cdot s}{4 k π \cdot L 2} ,$$

the second capacitance between two adjacent induction modules 11 adjacent to the middle position is

$$\frac{ɛ \cdot s}{4 k π \cdot L 3} ,$$

the second capacitance between two adjacent induction modules 11 away from the middle position is

$$\frac{ɛ \cdot s}{4 k π \cdot L 4} .$$

At last, the pressure value corresponding to the pressure is generated by the pressure generating module 122 according to a difference between the second capacitance and the first capacitance. Specifically, the difference between the second capacitance and the first capacitance, the pressure value, and a relationship between them can be stored in advance, as shown in table 1.

In this way, the pressure generating module 122 can calculate the difference between the second capacitance and the first capacitance after the capacitance detecting module 121 detects the first capacitance and the second capacitance. Subsequently, the pressure value corresponding to the difference can be found directly in the table 1. For example, as shown in FIG. 2, the pressure value corresponding to the middle position can be found according to the difference between the second capacitance and the first capacitance corresponding to the middle position, and the pressure value corresponding to the middle position can be found according to the difference between the second capacitance and the first capacitance close to the middle position.

According to some embodiments, the display device 1 also includes a heat dissipating layer 50, and the heat dissipating layer 50 is configured to dissipate heat. As shown in FIG. 6, the heat dissipating layer 50 is disposed on a side of the buffer layer 40 away from the support layer 30. The touch panel 10 is disposed on a side of the heat dissipating layer 50 away from the buffer layer 40.

In the display panel of the present disclosure, the plurality of induction modules disposed apart from each other are arranged at first, wherein the adjacent induction modules are formed a capacitor. Subsequently, a pressure value is generated to improve a detecting accuracy of the pressure value according to a various capacitance of the capacitor between the corresponding adjacent induction modules.

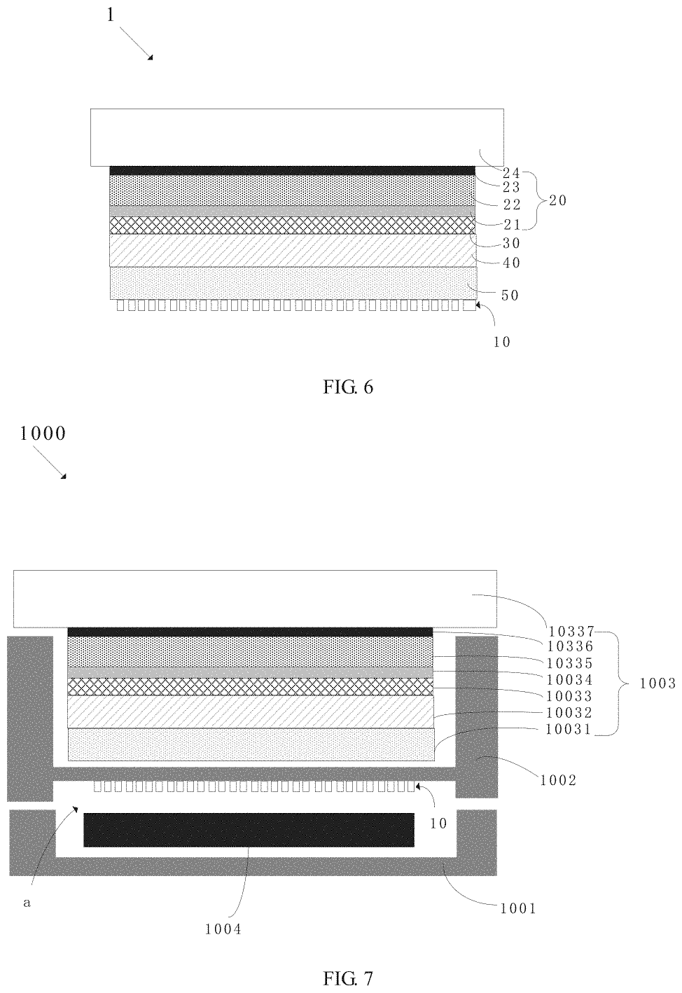

The present disclosure further provides a display device. Referring to FIG. 7, FIG. 7 is a structural schematic diagram of the display device according to the present disclosure. The display device 1000 includes a rear cover 1001, a middle frame 1002, a display panel 1003 and a touch panel 10. The middle frame 1002 is disposed on the rear cover 1001. The middle frame 1002 and the rear cover 1001 are configured to form a containing space a. The touch panel 10 is disposed on a side of the middle frame 1002 adjacent to the rear cover 1001 and is disposed in the containing space a, wherein a battery module 1004 is further stored in the containing space a, and the battery module 1004 is disposed between the touch panel 10 and the rear cover 1001.

As shown in FIG. 1, the touch panel 10 includes a plurality of induction modules 11 and a pressure detecting module 12. The plurality of induction modules 11 are disposed apart from each other, and the adjacent induction modules are formed a capacitor. As shown in the FIG. 2, when the touch panel 10 not being pressed, a separation distance between the adjacent bumps 11 is L1, and a capacitance of the capacitor between the adjacent induction modules is

$$\frac{ɛ \cdot s}{4 k π \cdot L 1} ,$$

wherein the ε is a permittivity of mediums disposed between the adjacent induction modules 11, the k is a electrostatic force constant, and the S is a relative area of the adjacent induction modules 11. When a middle position of the touch panel 10 being pressed, a separation distance between two adjacent induction modules 11 corresponding to the middle position is increased to L2, a separation distance between two adjacent induction modules 11 corresponding to two sides closed to the middle position is increased to L3, and a separation distance of two adjacent induction modules 11 corresponding to two sides away from the middle position is increased to L4. Similarly, capacitances of the capacitor between the adjacent induction modules 11 corresponding to relevant positions can be calculated to be

$$\frac{ɛ \cdot s}{4 k π \cdot L 2} , \frac{ɛ \cdot s}{4 k π \cdot L 3} and \frac{ɛ \cdot s}{4 k π \cdot L 4} .$$

Subsequently, a pressure value corresponding to a pressing can be generated according to various capacitances of the capacitor between the adjacent induction module 11 before and after the pressing.

Specifically, as shown in the FIG. 1, each induction module 11 includes a bump 111 and a conductive layer 112. There are a plurality of bumps 111 corresponding to a plurality of induction modules 11 accordingly. As shown in FIG. 3, the plurality of bumps 111 are distributed in a grid shape, two adjacent bumps 111 disposed along a first direction are connected by a bridge 113 and two adjacent bumps disposed along a second direction are connected by another bridge 113, and the first direction intersects with the second direction. According to an embodiment, the first direction can be a horizontal direction, and the second direction can be a vertical direction.

Materials of the bump 111 includes polyimide photoresists. As shown in FIG. 1, in order to improve a capacitance detecting accuracy of the induction module 11, a height H of the bump 111 can be ranged from 100 to 300 um, a width W of the bump 111 can be ranged from

$$\frac{H}{2}$$

to H um, and a separation distance L of two adjacent bumps 111 can be ranged

$$\frac{W}{5}$$

from to W um.

As shown in FIG. 4, the bump 111 includes a plurality of sub-bumps 1112, and a plurality of wires 1111 disposed at edges of the bump 111 wherein each of the plurality of wires 111 is connected to the corresponding sub-bump 1112.

The conductive layer 112 is disposed on the bump 111 and wraps the bump 111 wherein materials of the conductive layer 112 includes metal materials or graphite. According to an embodiment, the metal material is indium tin oxide.

As shown in FIG. 1, the pressure detecting module 12 is electrically connected to the plurality of induction modules 11. The pressure detecting module 12 is configured to generate a pressure value corresponding to a pressure according to various capacitances of the capacitor between the corresponding adjacent induction modules 11 before and after the touch panel 10 being pressed.

According to some embodiments, as shown in FIG. 1, the pressure detecting module 12 includes a capacitance detecting module 121 and a pressure generating module 122, wherein the capacitance detecting module 12 can detect a first capacitance of the capacitor between the corresponding adjacent induction modules 11 before the touch panel 10 is pressed, and detect a second capacitance of the capacitor between the corresponding adjacent induction modules 11 after the touch panel 10 is pressed. As shown in FIG. 2, the first capacitance detected by the capacitance detecting module 12 is

$$\frac{ɛ \cdot s}{4 k π \cdot L 1}$$

before the touch panel 10 is pressed, and the second capacitances detected by the capacitance detecting module 12 include

$$\frac{ɛ \cdot s}{4 k π \cdot L 2} , \frac{ɛ \cdot s}{4 k π \cdot L 3} and \frac{ɛ \cdot s}{4 k π \cdot L 4}$$

after the touch panel 10 is pressed, wherein the second capacitance between two induction modules 11 corresponding to the middle position is

$$\frac{ɛ \cdot s}{4 k π \cdot L 2} ,$$

the second capacitance between two adjacent induction modules 11 adjacent to the middle position is

$$\frac{ɛ \cdot s}{4 k π \cdot L 3} ,$$

the second capacitance between two adjacent induction modules 11 away from the middle position is

$$\frac{ɛ \cdot s}{4 k π \cdot L 4} .$$

At last, the pressure value corresponding to the pressure is generated by the pressure generating module 122 according to a difference between the second capacitance and the first capacitance. Specifically, the difference between the second capacitance and the first capacitance, the pressure value, and a relationship between them can be stored in advance, as shown in table 1.

In this way, the pressure generating module 122 can calculate the difference between the second capacitance and the first capacitance after the capacitance detecting module 121 detects the first capacitance and the second capacitance. Subsequently, the pressure value corresponding to the difference can be found directly in the table 1. For example, as shown in FIG. 2, the pressure value corresponding to the middle position can be found according to the difference between the second capacitance and the first capacitance corresponding to the middle position, and the pressure value corresponding to the middle position can be found according to the difference between the second capacitance and the first capacitance close to the middle position.

The display panel 1003 is disposed on the touch panel 10. Specifically, the display panel 1003 includes a heat dissipating layer 10031, a buffer layer 10032, a support layer 10033, a light-emitting layer 10034, a polarizer 10035, a touch layer 10036 and a cover plate 10037, wherein the heat dissipating layer 10031, the buffer layer 10032, the support layer 10033, the light-emitting layer 10034, the polarizer 10035, the touch layer 10036 and the cover plate 10037 are sequentially stacked from the bottom to upper.

The heat dissipating layer 10031 is configured to dissipate heat. The buffer layer 10032 is configured to relieve a pressure exerted on the display panel 1003. The support layer 30 is configured to support the light-emitting layer 10034, the polarizer 10035, the touch layer 1036 and the cover plate 10037 thereon. The light-emitting layer 10034 includes a thin-film transistor layer, an organic light-emitting layer and encapsulation layer, wherein the thin-film transistor layer is configured to drive the organic light-emitting layer. The encapsulation layer is configured to isolate external water and oxygen. According to an embodiment, the encapsulation layer is a thin-film encapsulation layer, and the thin-film encapsulation layer can be formed by combining a plurality of organic-inorganic thin-films, specifically. The polarizer 10035 is fixed on the encapsulation layer, and an optical cement can be coated on the encapsulation layer to fix the polarizer 10035. The polarizer 10035 is configured to adjust incident lights outside. A plurality of touch electrodes are disposed on the touch layer 10036 to assist to implement touch function. The cover plate 10037 has a characteristic of high hardness, and a layer with large roughness can be disposed thereon to improve a roughness characteristic of the display panel 1003.

In the display device of the present disclosure, the plurality of induction modules disposed apart from each other are arranged at first, wherein the adjacent induction modules are formed a capacitor. Subsequently, a pressure value is generated to improve a detecting accuracy of the pressure value according to various capacitances of the capacitor between the corresponding adjacent induction modules.

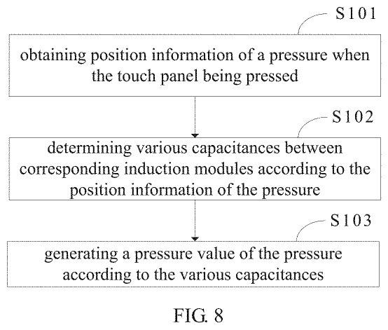

The present disclosure also provides a touch detecting method utilized for touch detecting the display panel 10. Referring to FIG. 8, FIG. 8 is a flowchart of the touch detecting method according to the present disclosure, and the method includes following steps:

S101, obtaining position information of a pressure when the touch panel being pressed.

A pressed position subjected to a pressure is deformable in a vertical direction when the touch panel is pressed, and peripheral position corresponding to the pressed position is also deformable in the vertical direction simultaneously. So, the position information of the pressure includes a pressed position the touch panel being pressed, and another pressed position surrounding the pressed position.

S102, determining various capacitances between corresponding induction modules according to the position information of the pressure.

As shown in FIG. 2, a middle position and a peripheral position of the touch panel 10 are deformable in the vertical direction when the middle position of the touch panel 10 being pressed. So, the position information of the pressure includes the middle position, two sides position adjacent to the middle position, and two sides position away from the middle position. A separation distance between two adjacent induction modules 11 corresponding to the middle position is increased from L1 to L2. A separation distance between two adjacent induction modules 11 corresponding to the two sides position adjacent to the middle position is increased from L1 to L3. A separation distance between two adjacent induction modules 11 corresponding to the two sides position away from the middle position is increased from L1 to L4. So, various capacitances of the capacitor between the adjacent induction modules 11 corresponding to relevant positions can be calculated to be

$$\frac{ɛ \cdot s}{4 k π \cdot L 2} - \frac{ɛ \cdot s}{4 k π \cdot L 1} , , \frac{ɛ \cdot s}{4 k π \cdot L 3} - \frac{ɛ \cdot s}{4 k π \cdot L 1} and \frac{ɛ \cdot s}{4 k π \cdot L 4} - \frac{ɛ \cdot s}{4 k π \cdot L 1} .$$

S103, generating a pressure value of the pressure according to the various capacitances.

A difference between the various capacitances, the pressure value, and a relationship between them can be stored in advance, as shown in following table 2. In this way, the pressure value corresponding to the difference between the various capacitances can be found directly in the table 2. For example, the pressure value corresponding to the middle position can be found according to the difference between various capacitances corresponding to the middle position, or the pressure value corresponding to the position adjacent to the middle position can be found according to the difference between various capacitances corresponding to the position adjacent to the middle position.

TABLE 2

| a difference between the second | |
|---|---|
| capacitance and the first capacitance | pressure value |
| ΔC1 | P1 |
| ΔC2 | P2 |
| ΔC2 | P3 |

In the touch detecting method of the present disclosure, the various capacitances between corresponding induction modules can be determined by obtaining the position information of the pressure. And then, a pressure value is generated to improve a detecting accuracy of the pressure value according to the various capacitances.

It should be understood that the specific embodiments described herein are only for explaining the present disclosure and are not intended to limit the present invention. This invention is not limited to the foregoing description of the disclosed embodiments. Various changes and modifications can be made to the invention in light of the above detailed description by those skilled in the art. These changes and modifications are possible within the scope of the invention as defined by the following claims.

What is claimed is:

1. A touch panel, comprising:
a plurality of induction modules disposed apart from each other, and the adjacent induction modules formed a capacitor;
a pressure detecting module electrically connected to the plurality of induction modules, and configured to generate a pressure value corresponding to a pressure according to various capacitances of the capacitor between the corresponding adjacent induction modules when the touch panel being pressed.

2. The touch panel as claimed in claim 1, wherein each of the plurality of induction modules comprises a bump and a conductive layer;
wherein the plurality of bumps are distributed in a grid shape, two adjacent bumps disposed along a first direction are connected by a bridge and two adjacent bumps disposed along a second direction are connected by another bridge, and the first direction intersects with the second direction;
wherein the conductive layer is disposed on the bump and wraps the bump.

3. The touch panel as claimed in claim 2, wherein a height H of the bump ranges from 100 to 300 um, a width W of the bump ranges from
$$\frac{H}{2}$$
to H um, and a separation distance between two adjacent bumps ranges from
$$\frac{W}{5}$$
to W um.

4. The touch panel as claimed in claim 2, wherein the bump comprises a plurality of sub-bumps and a plurality of wires disposed at edges of the bump;
wherein each of the plurality of wires is connected to the corresponding sub-bump.

5. The touch panel as claimed in claim 2, wherein materials of the conductive layer comprise metal materials or graphite.

6. The touch panel as claimed in claim 1, wherein the pressure detecting module comprises a capacitance detecting module and a pressure generating module;
wherein the capacitance detecting module is configured to detect a first capacitance of the capacitor between the corresponding adjacent induction modules before the touch panel is pressed, and to detect a second capacitance of the capacitor between the corresponding adjacent induction modules when the touch panel being pressed;
wherein the pressure generating module is configured to generate the pressure value according to a difference between the second capacitance and the first capacitance when the touch panel being pressed.

7. A display panel, comprising an organic light-emitting device, a support layer, a buffer layer, and a touch panel;
wherein the touch panel, the buffer layer, the support layer and the organic light-emitting device are sequentially stacked, and the buffer layer is disposed on the touch panel;
wherein the touch panel comprises:
a plurality of induction modules disposed apart from each other, and the adjacent induction modules formed a capacitor;
a pressure detecting module electrically connected to the plurality of induction modules, and configured to generate a pressure value corresponding to a pressure according to various capacitances of the capacitor between the corresponding adjacent induction modules when the touch panel being pressed.

8. The display panel as claimed in claim 7, wherein each of the plurality of induction modules comprises a bump and a conductive layer;
wherein the plurality of bumps are distributed in a grid shape, two adjacent bumps disposed along a first direction are connected by a bridge and two adjacent bumps disposed along a second direction are connected by another bridge, and the first direction intersects with the second direction;
wherein the conductive layer is disposed on the bump and wraps the bump.

9. The display panel as claimed in claim 8, wherein a height H of the bump ranges from 100 to 300 um, a width W of the bump ranges from
$$\frac{H}{2}$$
to H um, and a separation distance between two adjacent bumps ranges from
$$\frac{W}{5}$$
to W um.

10. The display panel as claimed in claim 8, wherein the bump comprises a plurality of sub-bumps and a plurality of wires disposed at edges of the bump;
wherein each of the plurality of wires is connected to the corresponding sub-bump.

11. The display panel as claimed in claim 8, wherein materials of the conductive layer comprise metal materials or graphite.

12. The display panel as claimed in claim 7, wherein the pressure detecting module comprises a capacitance detecting module and a pressure generating module;
wherein the capacitance detecting module is configured to detect a first capacitance of the capacitor between the corresponding adjacent induction modules before the touch panel is pressed, and to detect a second capacitance of the capacitor between the corresponding adjacent induction modules when the touch panel being pressed;
wherein the pressure generating module is configured to generate the pressure value according to a difference between the second capacitance and the first capacitance when the touch panel being pressed.

13. The display panel as claimed in claim 7, wherein the display panel comprises a heat dissipating layer;
wherein the heat dissipating layer is disposed on a side of the buffer layer away from the support layer;
wherein the touch panel is disposed on a side of the heat dissipating layer away from the buffer layer.

14. A display device, comprising a rear cover, a middle frame, a display panel and a touch panel;
wherein the middle frame is disposed on the rear cover, and the middle frame and the rear cover are configured to form a containing space;
wherein the touch panel is disposed on a side of the middle frame adjacent to the rear cover and is disposed in the containing space;
wherein the display panel is disposed on the touch panel;
wherein the touch panel comprises:
a plurality of induction modules disposed apart from each other, and the adjacent induction modules formed a capacitor;
a pressure detecting module electrically connected to the plurality of induction modules, and configured to generate a pressure value corresponding to a pressure according to various capacitances of the capacitor between the corresponding adjacent induction modules when the touch panel being pressed.

15. The display device as claimed in claim 14, wherein each of the plurality of induction modules comprises a bump and a conductive layer;
wherein the plurality of bumps are distributed in a grid shape, two adjacent bumps disposed along a first direction are connected by a bridge and two adjacent bumps disposed along a second direction are connected by another bridge, and the first direction intersects with the second direction;
wherein the conductive layer is disposed on the bump and wraps the bump.

16. The display device as claimed in claim 15, wherein a height H of the bump ranges from 100 to 300 um, a width W of the bump ranges from
$$\frac{H}{2}$$
to H um, and a separation distance between two adjacent bumps ranges from
$$\frac{W}{5}$$
to W um.

17. The display device as claimed in claim 15, wherein the bump comprises a plurality of sub-bumps and a plurality of wires disposed at edges of the bump;
wherein each of the plurality of wires is connected to the corresponding sub-bump.

18. The display device as claimed in claim 15, wherein materials of the conductive layer comprise metal materials or graphite.

19. The display device as claimed in claim 14, wherein the pressure detecting module comprises a capacitance detecting module and a pressure generating module;
wherein the capacitance detecting module is configured to detect a first capacitance of the capacitor between the corresponding adjacent induction modules before the touch panel is pressed, and to detect a second capacitance of the capacitor between the corresponding adjacent induction modules when the touch panel being pressed;
wherein the pressure generating module is configured to generate the pressure value according to a difference between the second capacitance and the first capacitance when the touch panel being pressed.

20. A touch detecting method for touch detecting by a touch panel as claimed in claim 1, comprising:
obtaining position information of a pressure when the touch panel being pressed;
determining various capacitances between corresponding induction modules according to the position information of the pressure;
generating a pressure value of the pressure according to the various capacitances.
